(19) United States
(12) Patent Application Publication
(10) Pub. No.: US 2013/0197916 A1
(43) Pub. Date: Aug. 1, 2013

(54) TERMINAL DEVICE, SPEECH RECOGNITION PROCESSING METHOD OF TERMINAL DEVICE, AND RELATED PROGRAM

(71) Applicant: Motonobu Sugiura, Ome-shi (JP)

(72) Inventor: Motonobu Sugiura, Ome-shi (JP)

(21) Appl. No.: 13/671,149

(22) Filed: Nov. 7, 2012

(30) Foreign Application Priority Data
Jan. 31, 2012 (JP) 2012-019325

(51) Int. Cl. G10L 15/08

(52) U.S. Cl. 704/275; 704/E15.002

(57) ABSTRACT

According to one embodiment, a terminal device including a main body, includes: a sound input module configured to receive a voice, convert the voice into a digital signal, and output the digital signal; a state detecting module having an acceleration sensor, configured to detect one or both of a movement and a state of the main body and output a detection result; an executing module, which is capable to execute plural speech recognition response processes, configured to execute one of the speech recognition response processes to the digital signal according to the detection result detected by the state detecting module.

### CROSS REFERENCE TO RELATED APPLICATION(S)

The application is based upon and claims the benefit of priority from Japanese Patent Application No. 2012-019325 filed on Jan. 31, 2012, the entire contents of which are incorporated herein by reference.

### BACKGROUND

1. Field

An embodiment relates to a terminal device in which control is made of how to respond to a speech recognition result, a control method of a terminal device, and a related program.

2. Description of the Related Art

In recent years, terminal devices such as smartphones, cell phones, and slate (tablet) personal computers (PCs) have been being developed and coming into wide use. Such terminal devices have various functions as well as telephone and communication means. And there are terminal devices having, as one of those functions, a function of recognizing a voice as a voice command using a speech recognition technology and thereby controlling, for example, the operation of one of various applications.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view showing an appearance of a terminal device according to an embodiment.

FIG. 2 is a general functional block diagram showing a main functional configuration of the terminal device according to the embodiment.

FIG. 3 is a flowchart showing the procedure of a control for confirming correctness of a speech recognition result and making a response in the terminal device according to the embodiment.

FIG. 4 shows an example image displayed in the terminal device according to the embodiment for the purpose of confirmation of correctness of a speech recognition result.

### DETAILED DESCRIPTION

According to one embodiment, a terminal device including a main body, includes: a sound input module configured to receive a voice, convert the voice into a digital signal, and output the digital signal; a state detecting module having an acceleration sensor, configured to detect one or both of a movement and a state of the main body and output a detection result; an executing module, which is capable to execute plural speech recognition response processes, configured to execute one of the speech recognition response processes to the digital signal according to the detection result detected by the state detecting module.

A terminal device according to an embodiment of the present invention will be hereinafter described with reference to the accompanying drawings. The embodiment is directed to a terminal device 1 which is in card form and allows the user to input an instruction by touching a display with his or her finger.

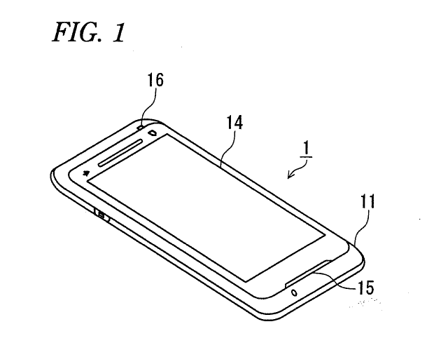

FIG. 1 is a perspective view showing an appearance of the terminal device 1 according to the embodiment.

The terminal device 1 is equipped with a rectangular, plate-like cabinet 11. One surface of the cabinet 11 is provided with a touch panel 14.

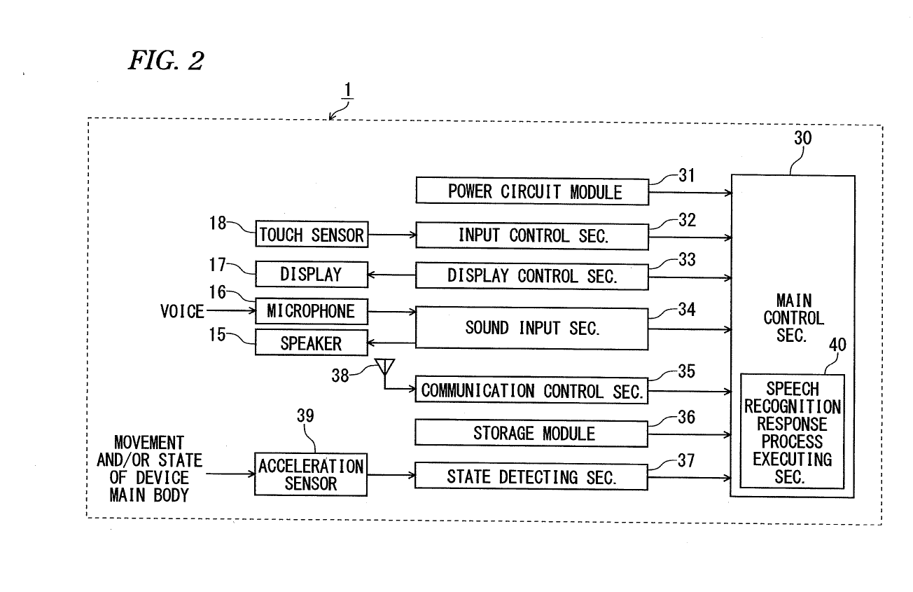

The touch panel 14 functions as both of a display module and an input module. The touch panel 14 is composed of a display 17 (see FIG. 2), plural devices provided on the top surface of the display 17 to detect a touch action, and a transparent manipulation surface (touch sensor 18 shown in FIG. 2) formed on those devices.

To function as the display module, the touch panel 14 has an area in which to display an image consisting of a text, a picture, etc. For example, the display 17 is an LCD (liquid crystal display), an organic EL (electroluminescence) display, or an inorganic EL display.

To function as the input module, the touch panel 14 receives an instruction by detecting an action of an object that is in contact with the manipulation surface.

A speaker 15 for outputting a sound and a microphone 16 for receiving a voice are disposed at two opposite end positions in the longitudinal direction on the same surface of the cabinet 11 as the touch panel 14 is provided.

FIG. 2 is a general functional block diagram showing a main functional configuration of the terminal device 1 according to the embodiment. The terminal device 1 is configured in such a manner that a main control module 30, a power circuit module 31, an input control module 32, a display control module 33, a sound input module 34, a communication control module 35, a storage module 36, and a state detecting module 37 are connected to each other by a bus so as to be able to communicate with each other.

The main control module 30 is equipped with a CPU (central processing module). The main control module 30 operates according to various programs stored in the storage module 36 and thereby performs a total control of the terminal device 1.

The power circuit module 31 is equipped with a power source. The power circuit module 31 switches the power on/off state of the terminal device 1 in response to a power on/off manipulation. While the terminal device 1 in the power-on state, the power circuit module 31 supplies power from the power source to the individual modules and modules and thereby renders the terminal device 1 operational.

The input control module 32 is equipped with an input interface for the touch sensor 18. The input control module 32 receives a detection signal from the touch sensor 18 every prescribed time as information indicating coordinates of an input position, generates a signal indicating the received information, and supplies the generated signal to the main control module 30.

The display control module 33 is equipped with a display interface for the display 17. The display control module 33 displays an image on the display 17 on the basis of document data or an image signal under the control of the main control module 30.

The sound input module 34 generates an analog audio signal from a voice picked up by the microphone 16 and converts the generated analog audio signal into a digital audio signal under the control of the main control module 30. When acquiring a digital audio signal, the sound input module 34 converts it into an analog audio signal and causes the speaker 15 to output it as a sound under the control of the main control module 30.

The communication control module 35 performs spectrum inverse spread processing on a reception that is transmitted from a base station and received by an antenna 38 under the control of the main control module 30 and thereby restores data. The data is supplied to the sound input module 34 and output from the speaker 15, supplied to the display control module 33 and displayed on the display 17, or stored in the storage module 36 according to an instruction from the main control module 30. When acquiring voice data picked up by the microphone 16, data that has been input through the touch panel 14, or data stored in the storage module 36, the communication control module 35 performs spectrum spread processing on the acquired data and sends resulting data to a base station via the antenna 38 under the control of the main control module 30.

The storage module 36 consists of a ROM (read only memory) for storing processing programs for pieces of processing to be performed by the main control module 30, data necessary for those pieces of processing, and other information, a hard disk drive, a nonvolatile memory, a database, a RAM (random access memory) for temporarily storing data that is used when the main control module 30 performs processing, etc. In particular, the storage module 36 stores processing programs for various processes to be executed by the main control module 30 in the embodiment.

Accompanied by an acceleration sensor 39, the state detecting module 37 detects one or both of a movement and a state of the terminal device main body and outputs a detection result. The phrase “one or both of a movement and a state” means one or both of a movement of the terminal device main body and, for example, whether the terminal device main body is kept horizontal or inclined from the horizontal posture to a certain degree or more.

The acceleration sensor 39 is a three-axis acceleration sensor, for example. The three-axis acceleration sensor can detect the magnitude and direction of acceleration occurring in a three-dimensional space by detecting its components using three sensors having three orthogonal detection axes (x, y, and z axes), respectively, and combining the detected components into a vector.

The storage module 36 is stored with plural predetermined speech recognition response processes correspond to respective digital signals to be output from the sound input module 34. The plural speech recognition response processes include at least a process of receiving a voice as a command and manipulating a predetermined application according to the received command. For example, in the case of document generation software, a process of storing a document being generated in response to a digital signal corresponding to a voice “Store” uttered by the user toward the microphone 16 is a speech recognition response process.

The storage module 36 is also stored with processing patterns indicating how to operate for respective predetermined movement/state pattern models each of which corresponds to a movement or a state of the terminal device main body or a combination thereof for each of the plural speech recognition response processes.

A speech recognition response process executing module 40 executes a speech recognition response process that is output from the storage module 36 according to a digital signal that is output from the sound input module 34.

The speech recognition response process executing module 40 performs a processing pattern that is determined according to a movement/state pattern model detected by the state detecting module 37 for a speech recognition response process that is output from the storage module 36 according to a digital signal that is output from the sound input module 34.

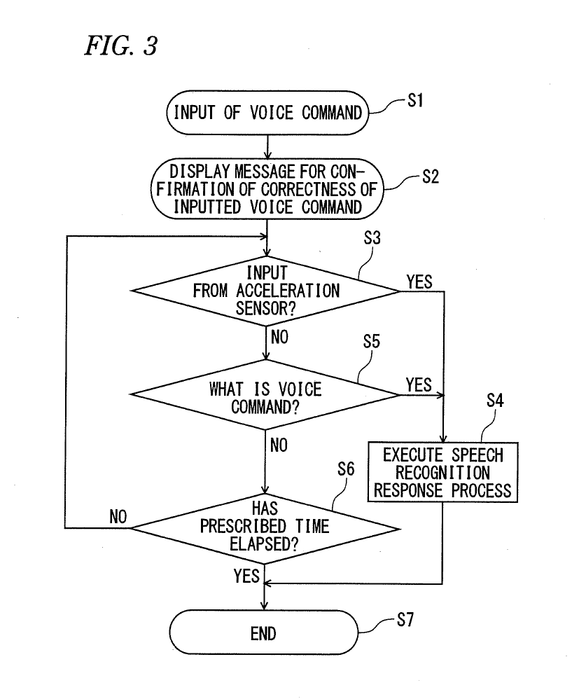

Next, how the terminal device 1 according to the embodiment operates will be described with reference to a flowchart of FIG. 3.

It is assumed that the device main body is powered on before a start of execution of the following steps.

First, at step S1, the sound input module 34 detects whether or not a voice has been input through the microphone 16 and outputs a corresponding digital signal if input of a voice is detected. The speech recognition response process executing module 40 judges whether or not the digital signal that is output from the sound input module 34 matches one of plural voice commands stored in the storage module 36.

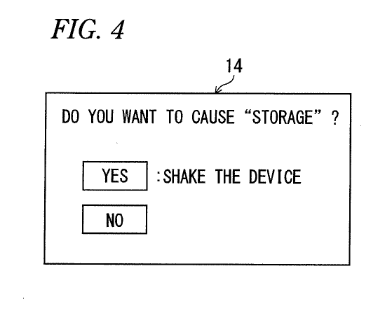

If a match is found, at step S2 a confirmation message that inquires of the user whether or not the inputted voice command is correct is displayed. FIG. 4 shows an example of such a confirmation message. More specifically, FIG. 4 shows an image containing a confirmation message of a case that the voice command is “Store.”

At step S3, the state detecting module 37 detects whether information indicating a motion and/or an inclination state of the device main body has been input from the acceleration sensor 39. If the state detecting module 37 detects input of such information from the acceleration sensor 39, at step S4 the speech recognition response process executing module 40 executes the speech recognition response process corresponding to the voice command that matches the digital signal that was output from the sound input module 34.

On the other hand, if the state detecting module 37 does not detect such information from the acceleration sensor 39 (S3: no), at step S5 the speech recognition response process executing module 40 judges whether or not a digital signal has been input again from the sound input module 34. If a voice “Yes” is input by the user through the microphone 16, at step S4 the speech recognition response process executing module 40 executes the speech recognition response process corresponding to the voice command that matches the digital signal that was output from the sound input module 34. On the other hand, if a voice “No” is input by the user through the microphone 16, the process moves to step S6.

If the speech recognition response process executing module 40 judges at step S6 that it has not received a digital signal from the sound input module 34 for a prescribed time (e.g., 3 seconds), the speech recognition response process executing module 40 cancels execution of the speech recognition response process. Then, the process of FIG. 3 is finished at step S7.

According to the above-described embodiment, the user can cause execution of a speed-recognized voice command merely by moving or inclining the device. That is, a simple action enables confirmation of correctness of a voice command and a response to it. Furthermore, correctness of a voice command can be confirmed and a response to it can be made more reliably without being affected by external noise.

The terminal device may be a portable TV receiver, a portable DVD recorder, or a portable Blu-ray recorder.

The above-described technique described in the embodiment can be distributed as a computer-executable program stored in a storage medium such as a magnetic disk (flexible disk, hard disk, or the like), an optical disc (CD-ROM, DVD, or the like), a magneto-optical disc (MO), or a semiconductor memory.

The above storage medium may be such as to employ any storage form as long as it can store the program and is computer-readable.

Part of the process to be executed to implement the embodiment may be executed by an OS (operating system), MW (middleware) such as a database management software or network software, or like software which operates on a computer according to instructions of a program that has been installed in the computer from a storage medium.

The storage medium used in the embodiment is not limited to a storage medium that is independent of a computer and may be a storage medium that is stored permanently or temporarily with a program downloaded over a LAN, the Internet, or the like.

The invention is not limited to the case of using a single storage medium, and the process according to the embodiment may be executed using plural storage media. In the latter case, the configuration of the storage media may be in any form.

The function of each of the modules described in the embodiment may be implemented by a software application that is executed by a computer, hardware processing circuits, hardware, or a combination of a software application, hardware, and software modules.

Although the embodiment of the invention has been described above, the embodiment is just an example and should not be construed as restricting the scope of the invention. The novel embodiment may be practiced in other various forms, and part of it may be omitted, replaced by other elements, or changed in various manners without departing from the spirit and scope of the invention. These modifications are also included in the invention as claimed and its equivalents.

What is claimed is:

1. A terminal device including a main body, comprising:
a sound input module configured to receive a voice, convert the voice into a digital signal, and output the digital signal;
a state detecting module having an acceleration sensor, configured to detect one or both of a movement and a state of the main body and output a detection result;
an executing module, which is capable to execute plural speech recognition response processes, configured to execute one of the speech recognition response processes to the digital signal according to the detection result detected by the state detecting module.

2. The terminal device according to claim 1, wherein
execution of the speech recognition response process is canceled if a state that the state detecting module does not detect a movement or a state of the main body has lasted for a prescribed time.

3. The terminal device according to claim 1 or 2, wherein
the acceleration sensor is a three-axis acceleration sensor.

4. A speech recognition processing method comprising:
receiving a voice;
converting the voice into a digital signal, and outputting the digital signal;
detecting one or both of a movement and a state of a main body with an acceleration sensor, and outputting a detection result;
executing a speech recognition response process that is output according to the digital signal based on a pattern corresponding to one or both of the movement and the state of the main body.

5. A recording medium for storing a program for causing a computer to execute the steps of:
receiving a voice;
converting the voice into a digital signal, and outputting the digital signal;
detecting one or both of a movement and a state of a main body with an acceleration sensor, and outputting a detection result;
executing a speech recognition response process that is output according to the digital signal based on a pattern corresponding to one or both of the movement and the state of the main body.
